(19) United States
(12) Patent Application Publication
(10) Pub. No.: US 2020/0236329 A1
(43) Pub. Date: Jul. 23, 2020

(54) PROJECTION SCREEN AND PROJECTION DISPLAY APPARATUS

(71) Applicant: SONY CORPORATION, TOKYO (JP)

(72) Inventor: HIDEHIKO TAKANASHI, KANAGAWA (JP)

(21) Appl. No.: 16/483,176

(22) PCT Filed: Feb. 8, 2018
(86) PCT No.: PCT/JP2018/004401

§ 371 Date: Aug. 2, 2019

(30) Foreign Application Priority Data
Feb. 16, 2017 (JP) 2017-026534

(51) Int. Cl. H04N 9/31; G02F 1/135; G02F 1/1347; G03B 21/60

(52) U.S. Cl. CPC H04N 9/315; G02F 1/1354; G02F 2001/1352; G03B 21/60; G02F 1/13475

(57) ABSTRACT

A projection screen according to an embodiment of the present disclosure includes a display member and a light-controlling layer stacked on the display member. The light-controlling layer includes a pair of conductive layers disposed to oppose each other, a liquid crystal layer provided between the pair of conductive layers, the liquid crystal layer including a liquid crystal and a dichroic pigment, and a photoconductive layer provided between one of the pair of conductive layers and the liquid crystal layer, and configured to have an application region whose resistance varies in accordance with application of light having a first wavelength.

### TECHNICAL FIELD

The present disclosure relates to a projection screen having a light-controlling function and a projection display apparatus provided therewith.

### BACKGROUND ART

In image display using a standard projector, background luminance represents black luminance. Consequently, in a bright environment where an amount of reflected light of a screen is large, contrast of a displayed image is reduced and visibility is aggravated, tendency of which is conspicuous in a transparent screen, in particular.

Making the black luminance lower than the background luminance allows for improvement of the aggravated visibility. For example, light-controlling of the screen is possible by combining a TFT (Thin Film Transistor) liquid crystal with a PDLC (Polymer Dispersed Liquid Crystal). However, in a case where the screen is formed by means of an active element such as the TFT, increase in costs, limitation on sizes, or the like occur, reducing an advantage of the projector, which is optionality of display size. Moreover, in the transparent screen, this contributes to a decrease in transmittance.

In contrast, PTL 1 discloses a screen including a first liquid crystal layer region and a second liquid crystal region, the first liquid crystal layer region being able to perform switching between a transmitting state and a scattering state by application of a voltage, and the second liquid crystal region including a liquid crystal and a dichroic pigment outside of the first liquid crystal layer region and being able to perform switching between the transmitting state and a colored state by the application of the voltage. In this screen, sense of contrast is increased by displaying an image in the first liquid crystal region put in the scattering state and putting the second liquid crystal region outside thereof in the colored state.

### CITATION LIST

### Patent Literature

PTL 1: Japanese Unexamined Patent Application Publication No. 2013-76955

### SUMMARY OF THE INVENTION

Accordingly, there has been a demand for development of a screen that allows for enhancement of visual quality including visibility.

It is desirable to provide a projection screen and a projection display apparatus that allow for the enhancement of the visual quality.

A projection screen according to an embodiment of the present disclosure includes a display member and a light-controlling layer stacked on the display member. The light-controlling layer includes a pair of conductive layers disposed to oppose each other, a liquid crystal layer provided between the pair of conductive layers, the liquid crystal layer including a liquid crystal and a dichroic pigment, and a photoconductive layer provided between one of the pair of conductive layers and the liquid crystal layer, and configured to have an application region whose resistance varies in accordance with application of light having a first wavelength.

A projection display apparatus according to an embodiment of the present disclosure includes a light source device, an image-generating optical system that generates image light by modulating light from the light source device on the basis of an inputted image signal, a projection optical system that projects image light generated by the image-generating optical system, and a projection screen that displays the image light projected from the projection optical system, the projection screen having components identical to the components of the projection screen according to the foregoing embodiment of the present disclosure.

In the projection screen and the projection display apparatus according to the respective embodiments of the present disclosure, the light-controlling layer including the liquid crystal layer and the photoconductive layer is stacked on the display member, the liquid crystal layer including the liquid crystal and the dichroic pigment, and the photoconductive layer has the application region whose resistance varies in accordance with the application of the light having the first wavelength. This makes it possible to cause black luminance of a desired region vary optionally.

According to the projection screen and the projection display apparatus according to the respective embodiments of the present disclosure, the light-controlling layer including the liquid crystal layer and the photoconductive layer is provided, the liquid crystal layer including the liquid crystal and the dichroic pigment, the photoconductive layer has the application region whose resistance varies in accordance with the application of the light having the first wavelength, which thus makes it possible to cause the black luminance of the desired region vary. Therefore, it is possible to enhance the visual quality of an image projected on the projection screen.

It is to be noted that the effects described here are not necessarily limiting and any of the effects that are described in the present disclosure may be provided.

### BRIEF DESCRIPTION OF DRAWINGS

FIG. 1 is a cross-sectional view of an example of a configuration of a screen according to a first embodiment of the present disclosure.

FIG. 2 is a cross-sectional view of another example of the configuration of the screen according to the first embodiment of the present disclosure.

FIG. 3 is an outline diagram illustrating an example of a configuration of a projection display apparatus including the screen illustrated in FIG. 1.

FIG. 4 is an outline diagram illustrating an example of a control system of the projection display apparatus illustrated in FIG. 3.

FIG. 5 is an outline diagram illustrating another example of the control system of the projection display apparatus illustrated in FIG. 3.

FIG. 6 is an outline diagram illustrating another example of the control system of the projection display apparatus illustrated in FIG. 3.

FIG. 7 is a schematic diagram illustrating image display in a standard projection display apparatus.

FIG. 8 is a schematic diagram illustrating the image display in the projection display apparatus illustrated in FIG. 3.

FIG. 9 is a cross-sectional view of a configuration of a screen according to a second embodiment of the present disclosure.

FIG. 10 is a view of an absorption axis of each liquid crystal layer in the screen illustrated in FIG. 9.

### MODES FOR CARRYING OUT THE INVENTION

In the following, some embodiments of the present disclosure are described in detail with reference to the drawings. It is to be noted that description is given in the following order.
1. First Embodiment (An example of a screen including a light-controlling layer having a liquid crystal layer and a photoconductive layer)
1-1. Configuration of Screen
1-2. Configuration of Projection Display Apparatus
1-3. Workings and Effects
2. Second Embodiment (An example of a screen including the light-controlling layer having a two-layer structure)

### 1. First Embodiment

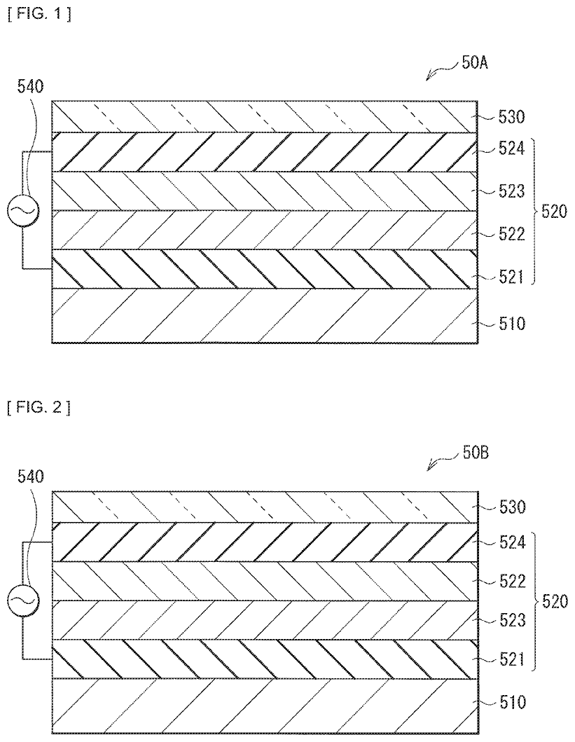

FIG. 1 illustrates an example of a cross-sectional configuration of a projection screen (screen 50A) according to a first embodiment of the present disclosure. The screen 50A displays an image generated in a projection section 60 of a projection display apparatus (projection display apparatus 1) to be described later. The screen 50A of the present embodiment has a configuration in which a light-controlling layer 520 is stacked on a display member 510. The light-controlling layer 520 is a stack of a conductive layer 521, a photoconductive layer 522, a liquid crystal layer 523, and a conductive layer 524 in this order. A transparent member 530 is provided on the light-controlling layer 520. It is to be noted that “images” used in the present disclosure include a static image and a moving image.

### 1-1. Configuration of Screen

The display member 510 is a commonly used screen member, and includes, for example, a matte screen, a pearl screen, a silver screen, a beads screen, and a transmissive screen, or the like. The matte screen is a so-called a diffusion screen including a fabric or a resin sheet, the fabric or the resin sheet having a paint including a scattering agent applied to a surface thereof. The pearl screen and the silver screen are each so-called a reflection screen, the reflection screen having pearl-based resin or a metal powder-based paint applied to a surface thereof. The beads screen is a screen a surface of which optical lens glass bulbs are applied to. The transmissive screen, when directly viewed, for example, has light-transmissivity to light having a wavelength in a visible region, and is a translucent screen including vinyl, acryl, glass, or the like. It is to be noted that any display member 510 suffices as long as the display member 510 reflects RGB light (image light Li) projected from the projection optical system 40, and, for example, a wall, etc. may be used, in addition to the fabric or the resin sheet mentioned above.

In addition to this, the display member 510 may include a hologram, a half mirror, a surface plasmon particle, a cholesteric liquid crystal, and a Fresnel lens, etc.

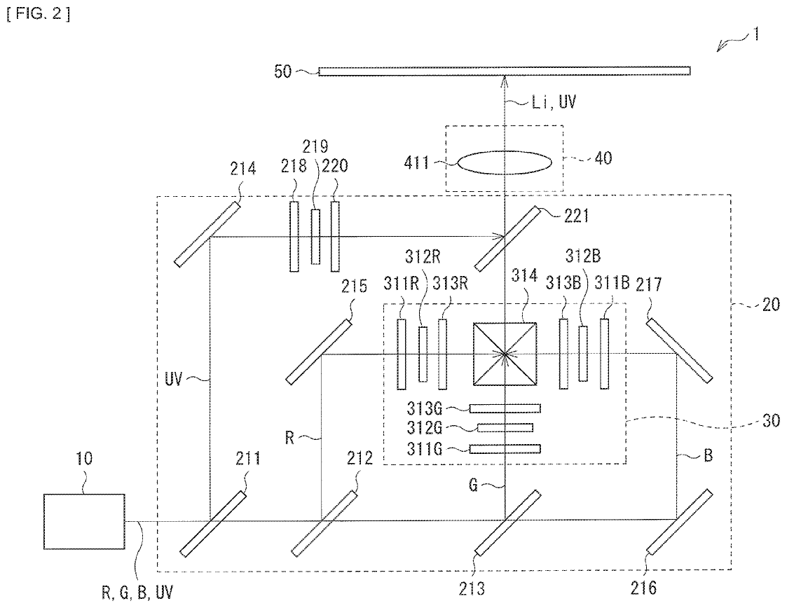

The light-controlling layer 520 is provided for causing black luminance of the screen 50A to vary by application of light (first light, light-controlled light (Lc)) having a wavelength different from wavelengths (RGB) that configure the image light (Li). The light-controlling layer 520 has a configuration that the photoconductive layer 522 and the liquid crystal layer 523 are stackingly disposed between the pair of conductive layer 521 and the conductive layer 524, the pair of conductive layer 521 and the conductive layer 524 being disposed to oppose each other. An order of stacking the photoconductive layer 522 and the liquid crystal layer 523 is not specifically limited. The photoconductive layer 522 may be disposed on side (surface S2 side) of the display member 510 with respect to the liquid crystal layer 523, as illustrated in FIG. 1, or may be disposed on side (surface Si side) opposite to the display member 510, like a screen 50B illustrated in FIG. 2. Here, the “light-controlling” refers to causing transmittance or reflectance of the screen to change to improve image contrast. In addition, the surface Si side represents observer side.

The conductive layers 521 and 524 apply a voltage supplied from a voltage application section 540 to the photoconductive layer 522 and the liquid crystal layer 523 and each include a light-transmissive conductive material, for example. The light-transmissive conductive material includes, for example, an ITO (indium tin oxide), a dopant-added tin-oxide (SnO₂) based material, and a zinc-oxide based material made by adding a dopant to an aluminum zinc oxide (ZnO). The zinc-oxide based material includes, for example, the aluminum zinc oxide (AZO) to which aluminum (Al) is added as the dopant, a gallium zinc oxide (GZO) to which gallium (Ga) is added, or an indium zinc oxide (IZO) to which indium (In) is added. In addition to this, CuI, InSbO₄, ZnMgO, CuInO₂, MgIN₂O₄, CdO, ZnSnO₃, or the like may also be used.

The photoconductive layer 522 has an application region whose resistance varies in accordance with the application of the light-controlled light (Lc) and includes an organic photo conducting agent, for example. It is preferable that the organic photo conducting agent have absorption with respect to a predetermined wavelength (light-controlled light (Lc) in the present embodiment), but have no absorption to any wavelength band other than the predetermined wavelength, such as a visible region, in particular. This makes it possible to prevent a reduction in color representation of the image. It is preferable to use light having a wavelength ranging from, for example, more than or equal to 350 nm and less than or equal to 420 nm or more than or equal to 700 nm and less than or equal to 2.5 μm as the light-controlled light (Lc). Specifically, the light-controlled light (Lc) includes ultraviolet rays (UV) or infrared rays (IR). That is, it is preferable that the organic photo conducting agent selectively absorb the wavelength ranging from 350 nm to 420 nm or 700 nm to 2.5 μm. Such an organic photo conducting agent includes one in which a charge transfer complex or a combination of a carrier generation material and a carrier transport material are dispersed in a polymer molecule. Specific examples of the polymer molecule include polycarbonate, polyester, polyvinyl acetate, or polyketal, for example. Specific examples of the charge transfer complex include a polyvinylcarbazole-trinitrofluorenone complex and a tetrathiafulvalene-tetracyanoquinodimethane complex, for example. Specific examples of the carrier generation materials include a thiopyrylium pigment, an azo colorant, a perylene colorant, an anthanthrone colorant, a phthalocyanine colorant, a squarylium colorant, and a dithioketo-pyrrolo-pyrrole colorant, for example. Specific examples of the carrier transport material include arylamines, hydrazones, stilbenes, benzidines, azoquinones, pyrazolines, oxadiazoles, and triphenylmethanes, for example. In addition, not only the organic photo conducting agent but also an inorganic photo conducting agent, such as Se or an alloy thereof, a-Si, CdS, ZnO, etc. may be used.

The liquid crystal layer 523 is configured by a so-called guest host type liquid crystal including a liquid crystal (host) and a dichroic pigment (guest). With application of a voltage, not only an orientation direction of the host varies but also an orientation direction of the dichroic pigment varies, which achieves optical modulation (variation in the transmittance or reflectance). It is preferable that the dichroic pigment have large absorbance along a long axis direction of a molecule and also have small absorption in a short axis direction that is orthogonal to the long axis. Specifically, the dichroic pigment includes, for example, an azo pigment, an anthraquinone pigment, a dioxazine pigment, a perylene pigment, a quinophthalone pigment, a naphthoquinone pigment, an azomethine pigment, a tetrazine pigment, and a merocyanine pigment, etc.

The liquid crystal layer 523 is display driven by, for example, VA (Vertical Alignment) mode, TN (Twisted Nematic) mode, ECB (Electrically controlled birefringence) mode, FFS (Fringe Field Switching) mode, PDLC mode, or IPS (In Plane Switching) mode, etc.

The transparent member 530 is provided to hold a thickness of the liquid crystal layer 523. The transparent member 530 is configured by a light-transmissive material and includes, a glass substrate, for example. In addition to this, a transparent high-polymer material such as polyethylene terephthalate, polyethylene naphthalate, polycarbonate, acrylic resin, olefin resin, fluorine resin, polyimide resin, styrene resin, etc. may be used.

In the screen 50A of the present embodiment, in a case where the light-controlled light (Lc) is applied, the resistance of the photoconductive layer 522 in the application region varies (decreases), and the voltage supplied from the voltage application section 540 is applied to the liquid crystal layer 523. In the liquid crystal layer 523, with the application of the voltage, the orientation direction of the liquid crystal varies, and correspondingly, the orientation direction of the dichroic pigment also varies, which varies the transmittance or the reflectance of the application region. Specifically, the application region of the light-controlled light (Lc) is colored black. This makes it possible to reduce the black luminance of a desired region of the screen 50A to a value less than or equal to environmental luminance.

It is to be noted that although FIG. 1 and FIG. 2 illustrate a case where the liquid crystal layer 523 is disposed on the surface S1 side (observer side) and the display member 510 is disposed on the surface S2 side (side opposite to the observer), the configuration is not limited thereto. For example, in a case where the display member 510 is configured by a member that reflects a whole wavelength of the visible region, the configuration illustrated in FIG. 1 and FIG. 2 is preferable. However, in a case where the display member 510 is configured by the transmissive screen or the half mirror, the liquid crystal layer 523 may be disposed on the surface S2 side (side opposite to the observer) and the display member 510 may be disposed on the surface S1 side (observer side).

In addition, for example, an alignment film may be provided on the surface S1 side and the surface S2 side of the liquid crystal layer 523, depending on a display mode of the liquid crystal layer 523.

Furthermore, a protective layer may be provided between the display member 510 and the light-controlling layer 512, the protective layer selectively absorbing or reflecting the ultraviolet rays (UV) or the infrared rays (IR), and the ultraviolet rays (UV) or the infrared rays (IF) being used as the light-controlled light (Lc). The protective layer is to cut down application of the light-controlled light (Lc) to the display member 510 to prevent deterioration (yellowing) of the display member 510 due to the application of the light-controlled light (Lc). Materials of the protective layer include, for example, a scattering agent such as zinc oxide, titanium oxide, etc., or an absorbing agent such as methoxycinnamic acid octyl (or ethylhexyl methoxycinnamate), t-butyl methoxydibenzoylmethane, oxybenzone-3, cyanine pigments, phthalocyanine pigments, squarylium pigments, etc.

### 1-2. Configuration of Projection Display Apparatus

The projection display apparatus 1 of the present embodiment includes the screen 50 and the projection section 60, the screen 50 including the screen 50A or the screen 50B described above. The projection section 60 includes the light source device 10, a lighting optical system 20, an image forming section 30, and the projection optical system 40 in sequence. It is to be noted that the lighting optical system 20 and the image forming section 30 correspond to a specific example of an image-generating optical system of the present disclosure. FIG. 3 illustrates an example of a configuration of the projection display apparatus 1. Although FIG. 3 exemplifies a projection display apparatus of a transmissive 3 LCD (liquid crystal display) method that performs light modulation with transmissive liquid crystal panels (liquid crystal panels 312R, 312G, and 312B), the configuration is not limited thereto. For example, the projection display apparatus 1 may be configured as a projection display apparatus of a reflection 3 LCD method that performs the light modulation with a reflection liquid crystal panel.

It is to be noted that the projection display apparatus 1 of the present embodiment may also be applied to a projector using, for example, an LCOS (Liquid crystal on silicon), a MEMS (Micro Electro Mechanical Systems) mirror, or a digital micromirror device (DMD: Digital Micro-mirror Device), etc., instead of the transmissive liquid crystal panels or the reflection liquid crystal panel.

In the light source device 10, a light source necessary for color image display, is disposed, the light source emitting white light that includes red light (R), blue light (B), and green light (G). In the present embodiment, in the light source device 10, there is further disposed a light source emitting, as the light-controlled light (Lc), any light (for example, UV) other than RGB. The light sources are configured by, for example, a halogen lamp, a metal halide lamp, or a xenon lamp, etc. In addition, for example, a solid-state light source such as a semiconductor laser (LD), or a light emitting diode (LED), or the like may also be used. An optical system of the light source for the color image display is also used as the light sources for light controlling. This facilitates alignment of a displayed image using the image light (Li) with an image using the light-controlled light (Lc) and simplifies a structure of the projection display apparatus 1.

The lighting optical system 20 includes dichroic mirrors 211, 212, and 213, and total reflection mirrors 214, 215, 216, and 217, for example.

The dichroic mirror 211 is disposed on an optical path of the light source and has a function to separate light (R, G, B, and UV) emitted from the light source device 10 into ultraviolet rays (UV) and other light (R, G, and B). The dichroic mirror 211 is similarly disposed on the optical path of the light source, and has the function to separate the light (R, G, and B) passing through the dichroic mirror 211 into the red light (R) and other light (G and B). The dichroic mirror 212 is similarly disposed on the optical path of the light source and has the function to separate the light (G and B) passing through the dichroic mirror 212 into the green light (G) and other light (blue light (B)).

The total reflection mirror 214 is disposed on an optical path of ultraviolet rays reflected by the dichroic mirror 211 and reflects the ultraviolet rays (UV) reflected by the dichroic mirror 211 toward a polarizing plate 218. The total reflection mirror 215 is disposed on the optical path of the red light (R) reflected by the dichroic mirror 212 and reflects the red light (R) reflected by the dichroic mirror 212 toward a polarizing plate 311R. The total reflection mirror 216 is disposed on the optical path of the blue light (B) passing through the dichroic mirror 213 and reflects the blue light (B) passing through the dichroic mirror 213 toward the total reflection mirror 217. The total reflection mirror 217 is disposed on the optical path of blue light (B) reflected by the total reflection mirror 216 and reflects the blue light (B) toward a polarizing plate 311B.

The image forming section 30 includes the polarizing plates 311R, 311G and 311B, the liquid crystal panels 312R, 312G, and 312B, polarizing plates 313R, 313G, and 313B, and a dichroic prism 314.

The polarizing plate 311R is disposed on the optical path of the red light (R) and has a function to separate, on a polarization separation plane, the inputted red light (R) into two polarization components that are orthogonal to each other. The polarizing plate 311G is disposed on the optical path of the green light (G) and has a function to separate, on a polarization separation plane, the inputted green light (G) into the two polarization components that are orthogonal to each other. The polarizing plate 311B is disposed on the optical path of the blue light (B) and has a function to separate, on a polarization separation plane, the inputted blue light (B) into the two polarization components that are orthogonal to each other. Each of the respective polarization separation planes reflects one polarization component (for example, a S-polarization component) while transmitting other polarization component (for example, a P-polarization component).

The liquid crystal panels 312R, 312G, and 312B are the transmissive liquid crystal panels and generate image light of each color by modulating inputted light on the basis of an inputted image signal. The liquid crystal panel 312R is disposed on the optical path of the red right (R) reflected on the polarization separation plane of the polarizing plate 311R. The liquid crystal panel 312R is driven by a digital signal, the digital signal being pulse-width modulated (PWM) in accordance of a red image signal, for example, and thereby modulates the inputted light. In addition to this, the liquid crystal panel 312R has a function to transmit the modulated light toward the polarizing plate 313R. The liquid crystal panel 312G is disposed on the optical path of the green light (G) reflected on the polarization separation plane of the polarizing plate 311G. The liquid crystal panel 312G is driven by the digital signal, the digital signal being pulse-width modulated (PWM) in accordance with a green image signal, for example, and thereby modulates the inputted light. In addition to this, the liquid crystal panel 312G has the function to transmit the modulated light toward the polarizing plate 313G. The liquid crystal panel 312B is disposed on the optical path of the blue light (B) reflected on the polarization separation plane of the polarizing plate 311B. The liquid crystal panel 312B is driven by the digital signal, the digital signal being pulse-width modulated (PWM) in accordance with a blue image signal, for example, and thereby modulates the inputted light. In addition to this, the liquid crystal panel 312B has the function to transmit the modulated light toward the polarizing plate 313B.

Similarly to the foregoing polarizing plates 311R, 311G, and 311B, the polarizing plates 313R, 313G, and 313B are disposed on the optical paths of the light of the respective colors (R, B, and B) that pass through the respective liquid crystal panels 312R, 312G, and 312B, and each have the function to separate, on the polarization separation plane, the inputted color light (R, G, and B) into the two polarization components that are orthogonal to each other. Each of the polarization planes reflects one polarization component (for example, the S-polarization component), while transmitting the other polarization component (for example, the P-polarization component) to cause the one polarization component to enter the dichroic prism 314.

The dichroic prism 314 overlaps and combines the red light (R), the green light (G), and the blue light (B) inputted from three directions, and outputs the combined image light (Li) to the projection optical system 40.

The ultraviolet rays (UV) reflected by the total reflection mirror 214 to the polarizing plate 218 are separated on the polarization separation plane of the polarizing plate 218 into the two polarization components that are orthogonal to each other. The polarization separation plane reflects the one polarization component (for example, the S-polarization component), while transmitting the other polarization component (for example, the P-polarization component).

Similarly to the liquid crystal panels 312R, 312G, and 312G, the liquid crystal panel 219 is the transmissive liquid crystal panel and generates the light-controlled light (Lc) by modulating the inputted light on the basis of the inputted image signal. The liquid crystal panel 219 is disposed on the optical path of the ultraviolet rays reflected on the polarization separation plane of the polarizing plate 311R. It is to be noted that MEMS (Micro Electro Mechanical Systems) such as a DLP (digital light processing), etc. may be used in the light modulation for the light-controlled light. In a case where the ultraviolet rays (UV) are used as the light-controlled light (Lc), in particular, it is preferable to use the MEMS that is less susceptible to the ultraviolet rays (UV) because deterioration of the liquid crystal panels is a concern.

The polarizing plate 220 is disposed on the optical path of the ultraviolet rays ((UV), and the light-controlled light (Lc)) that are dropped on the liquid crystal panel 219, and has the function to separate on the polarization separation plane the inputted ultraviolet rays (UV) into the two polarization components that are orthogonal to each other. Each of the polarization separation planes reflects the one polarization component (for example, the S-polarization component), while transmitting the other polarization component (for example, the P-polarization component) toward the dichroic mirror 221.

The dichroic mirror 221 is disposed on the optical path of the image light (Li) and the light-controlled light (Lc) and transmits the image light (Li). The dichroic mirror 221 also reflects the light-controlled light (Lc), and outputs the image light (Li) and the light-controlled light (Lc) to the projection optical system 40.

The projection optical system 40 includes a plurality of lenses including a projection lens 411. The projection optical system 40 expands the image light (Li) combined by the dichroic prism 314 and the light-controlled light (Lc) reflected by the dichroic mirror 221, and projects the image light (Li) and the light-controlled light (Lc) toward the screen 50.

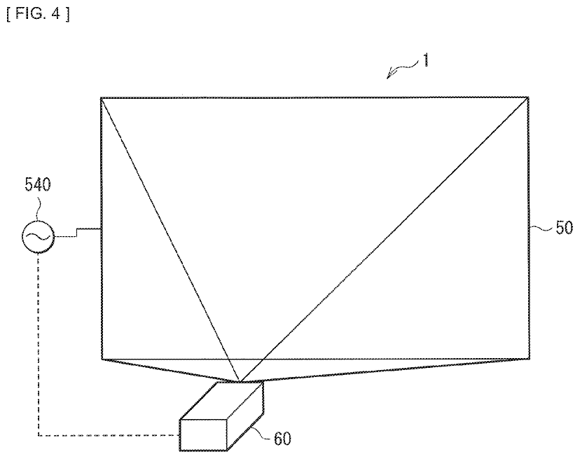

FIG. 4 schematically illustrates a control system of the projection display apparatus 1. In the projection display apparatus 1 of the present embodiment, it is preferable to synchronize driving of the liquid crystal layer 523 in the screen 50 with projection of the light-controlled light (Lc) in the projection section 60.

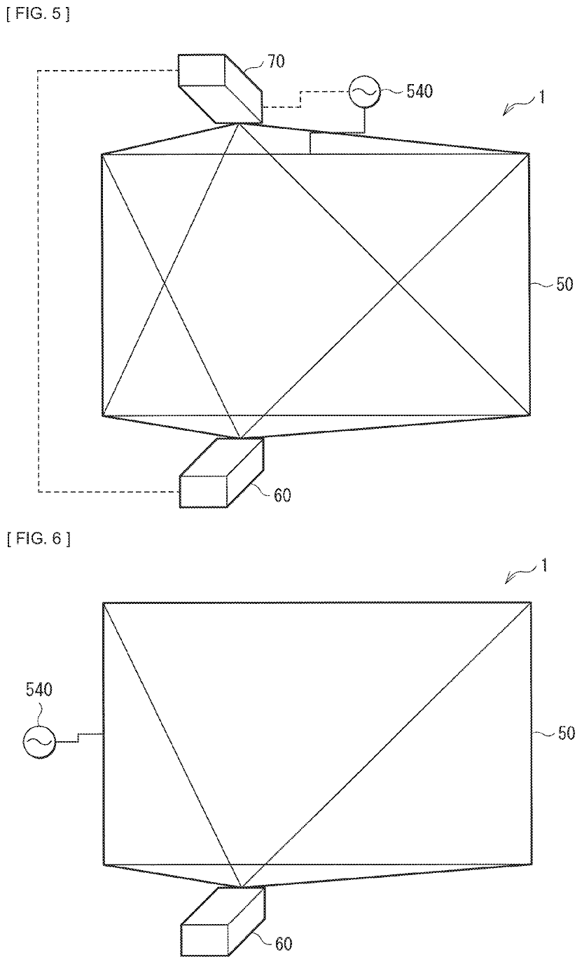

In addition, a common optical system is not necessarily used for the light source for the image light (Li) and the light source for the light-controlled light (Lc). If the display image using the image light (Li) is aligned with the image using the light-controlled light (Lc), as illustrated in FIG. 5, the light-controlled light (Lc) may be applied to the screen 50 from a projection section 70, the projection section 70 being configured by means of an optical system which is different from the optical system of the light source for the image light (Li). In that case, it is preferable that the driving of the screen 50, projection system of the image light (Li) in the projection section 60, and projection of the light-controlled light (Lc) in the projection section 70 be synchronized.

Furthermore, although FIG. 5 illustrates an example where the projection sections 60 and 70 are disposed on the same surface of the screen 50 (surface S1, for example), the example is not limited thereto. For example, in a case where the display member 510 includes the transmissive screen or the half mirror, one of the projection sections 60 and 70 may be disposed on the side of the surface S1 of the screen 50, and the other of the projection sections 60 and 70 may be disposed on the side of the surface S2 of the screen 50.

It is to be noted that in a case where time constants of the photoconductor layer 522 and the liquid crystal layer 523 are comparable with or smaller than a frame rate of an application electric field, as illustrated in FIG. 6, the driving of the screen 50 may not be synchronized with the projection of the image light (Li) and the projection of the light-controlled light (Lc). One reason for this is that the time constants of the photoconductive layer 522 and the liquid crystal layer 523 make it difficult that a colored state (black state, for example) written to the screen 50 with respect to the image projected on the screen 50 remains unerased.

### 1-3. Workings and Effects

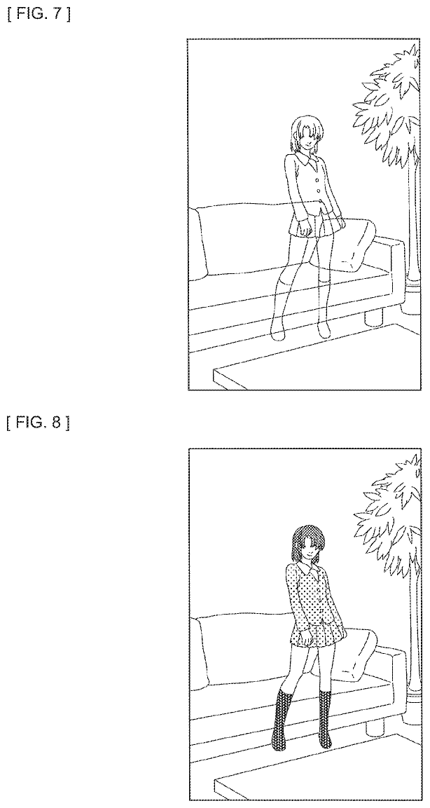

As described above, in image display using a standard projector, reduced contrast in a bright environment, that is, reduced visibility, is problematic. One reason for this is that background luminance is the black luminance of the screen, tendency of which is conspicuous in a transparent screen, in particular. For example, as illustrated in FIG. 7, in a case where an image of a person, for example, is projected on the transparent screen, background is seen through, and a black part, in particular, is buried in the background. If it was possible to make the black luminance lower than the background luminance, observation of an image by a projector in a bright location would be allowed, which thus expands a range of utilization of a projector device.

As a method of making a desired region darker than the background luminance in accordance with display, formation of the screen by means of an active element such as a TFT is possible. However, this case results in increased costs or limited size, or the like, reducing an advantage of the projector, which is optionality of display size. Moreover, in the transparent screen, this contributes to a decrease in the transmittance. For example, in a transparent OLED (Organic Light Emitting Diode) display, even in a case where the transmittance is increased by disposition of a light emitting section on wiring, etc., the transmittance thereof is still about 50%. A projection screen of the projector requires the transmittance higher than or equal to that. In addition to this, a screen has also been developed that increases feel of contrast by placing a liquid crystal region that is able to perform switching between a transmitting state and a colored state, outside of the liquid crystal region that is able to perform switching between the transmitting state and a scattering state.

As such, there has been a demand for development of a screen and a projection display apparatus provided therewith, the screen being able to reduce luminance of the desired region to a value less than or equal to the environmental luminance while ensuring the optionality of a projection size.

In contrast, in the screen 50 of the present embodiment, the light-controlling layer 520 is stacked on the display member 510, the display member including a standard screen member. The light-controlling layer 520 is such configured that the photoconductive layer 522 and the liquid crystal layer 523 are sandwiched by the pair of conductive layers 521 and 524, the photoconductive layer 522 having the application region whose resistance varies in accordance with application of light having a predetermined wavelength, and the liquid crystal layer 523 including the liquid crystal and the dichroic pigment. As described above, in the light-controlling layer 520, in a case where the light (light-controlled light (Lc)) having the predetermined wavelength is applied, the resistance of the photoconductive layer 522 in the application region is reduced, and the voltage supplied from the voltage application section 540 is applied to the liquid crystal layer 523. In the liquid crystal layer 523, due to the application of the voltage, the orientation direction of the dichroic pigment in the application region varies with the liquid crystal, increasing absorption of light. Specifically, the application region is colored black, for example, which makes it possible to reduce the black luminance of the desired region of the screen 50 (black part of an image generated in the projection section 60, for example) to a value less than or equal to the environmental luminance. As illustrated in FIG. 8, this makes it possible to display the image with the background not seen through even in a case where the display member 510 includes the transmissive screen. That is, the contrast improves, which allows for enhancement of the visibility.

As described above, in the screen 50 of the present disclosure, the light-controlling layer 520 is stacked on the display member 510, the light-controlling layer 520 having the transmittance or the reflectance that varies in accordance with the application of the light (light-controlled light (Lc)) having the predetermined wavelength. This makes it possible to reduce the black luminance of the desired region of the screen 50, the black part of the projected image, in particular, to a value less than or equal to the environmental luminance, thus enhancing the visibility. Therefore, it is possible to provide the screen 50 with the excellent visual quality and the projection display apparatus 1 provided therewith.

Moreover, in the projection display apparatus 1 of the present embodiment, the light source for the light-controlled light is used in addition to the RGB light source that forms the image light (Li), and the optical system (lighting optical system 20 and projection optical system 40) common to the image light (Li) is used as the optical system for the light-controlled light (Lc). This simplifies the configuration of the projection section 60 and makes an optical axis of the light-controlled light (Lc) applied to the screen 50 substantially identical to that of the image light (Li). This makes it possible to reduce a position gap between a light-controlled region and an image display region.

Next, description is given of a second embodiment of the present disclosure. In the following, components identical to the components of the foregoing first embodiment are denoted by same reference numerals, and description thereof is omitted where appropriate.

### 2. Second Embodiment

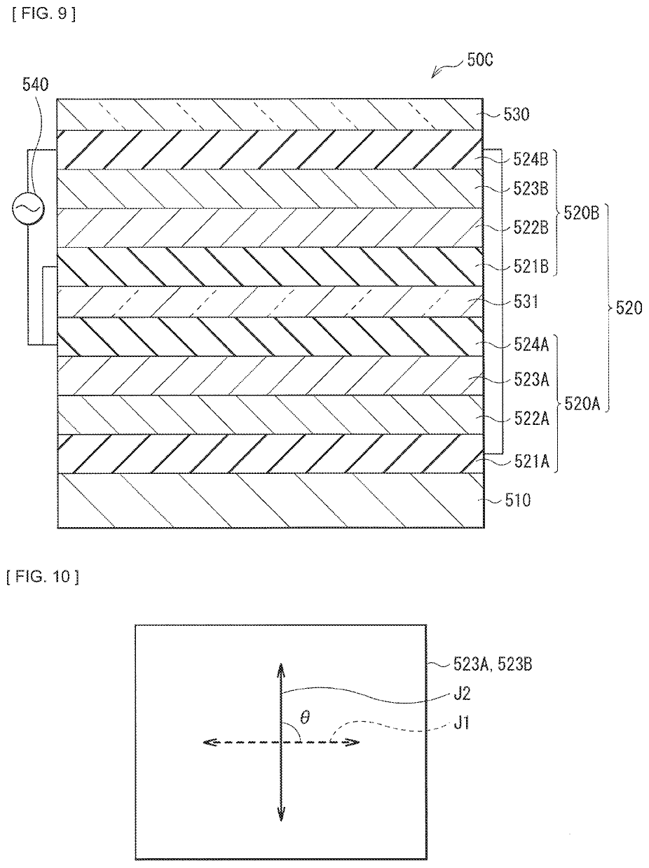

FIG. 9 illustrates an example of a cross-sectional configuration of a projection screen (screen 50C) according to the second embodiment of the present disclosure. Similarly to the foregoing first embodiment, the screen 50C displays the image generated in the projection section 60 as the screen 50 of the foregoing projection display apparatus (projection display apparatus 1). The screen 50C has the light-controlling layer 520 and the transparent member 530 stacked on the display member 510 in this order. The present embodiment differs from the foregoing first embodiment in that the light-controlling layer 520 has a two-layer structure (the first layer 520A and the second layer 520B).

In each of the first layer 520A and the second layer 520B that are included in the light-controlling layer 520, a photoconductive layer 522A and a liquid crystal layer 523A (photoconductive layer 522B and liquid crystal layer 523B) are stackingly disposed between a pair of a conductive layer 521A and a conductive layer 524A (conductive layer 521B and conductive layer 524B). Specifically, the first layer 520A has a configuration that the conductive layer 521A, the photoconductive layer 522A, the liquid crystal layer 523A, and the conductive layer 524A are stacked in this order. The second layer 520B has a configuration that the conductive layer 521B, the photoconductive layer 522B, the liquid crystal layer 523B, and the conductive layer 524B are stacked in this order. The first layer 520A and the second layer 520B are stacked sequentially via the transparent member 531.

The respective layers included in the first layer 520A and the second layer 520B include the similar materials to the respective layers included in the light-controlling layer 520 as described in the first embodiment. It is preferable, however, that, as illustrated in FIG. 10, the liquid crystal that configures the liquid crystal layers 523A and 523B have absorption axes J1 and J2, the absorption axes J1 and J2 being different from each other. It is preferable that an angle θ between respective bearings of the absorption axis J1 of the liquid crystal 523A and the absorption axis J2 of the liquid crystal layer 523B be 90° in a planar view, for example. This improves light absorption in the light-controlling layer 520. That is, it is possible to efficiently reduce the black luminance.

The transparent member 531 provided between the first layer 520A and the second layer 520B is to electrically isolate two electrodes (the conductive layer 524A of the first layer 520A and the conductive layer 521B of the second layer 520B) disposed to oppose each other, and includes the similar material to the foregoing transparent member 530, for example. The transparent member 531 has a thickness, for example, ranging from 1 μm to 200 μm, as far as the conductive layer 524A of the first layer 520A is electrically isolated from the conductive layer 521B of the second layer 520B.

In the present embodiment, the voltage application section 540 has, for example, one side coupled to the conducive layer 524A of the first layer 520A and the conductive layer 521B of the second layer 520B, while having the other side coupled to the conductive layer 524B of the second layer 520B. The conductive layer 524B is electrically coupled to the conductive layer 521A of the first layer 520A. This makes it possible to simultaneously drive the liquid crystal layer 523A of the first layer 520A and the liquid crystal layer 523B of the second layer 520B.

As described above, in the present embodiment, the light-controlling layer 520 is configured by means of the two kinds of liquid crystal layers (liquid crystal layers 523A and 523B), the liquid crystal layers 523A and 523B having mutually different bearings of the absorption axes. In general, the dichroic pigment has a single absorption axis. Accordingly, provision of the liquid crystal layers 523A and 523B with the mutually different absorption axes J1 and J2 efficiently improves the light absorption in the light-controlling layer 520. That is, it is possible to efficiently reduce the black luminance, thus allowing for further enhancement of the visual quality.

Although description has been given of the present disclosure with reference to the first embodiment and the second embodiment, the present disclosure is not limited to the foregoing embodiments, etc., and various modifications may be made thereto. For example, the materials or thickness, etc. of the respective members that configure the screen (screens 50A, 50B, or 50C) described in the foregoing embodiments are merely examples and are not limited thereto. The screen may have other materials or thickness. In addition, the configuration of the projection display apparatus 1 described in the foregoing first embodiment is merely an example, and it is not necessary that the projection display apparatus 1 have all of the optical members. The projection display apparatus 1 may also be configured by means of other optical members.

Moreover, in the foregoing second embodiment, although the light-controlling layer 520 is configured by means of the liquid crystal layers 523A and 523B having the mutually different absorption axes J1 and J2, the light-controlling layer 520 is not limited thereto. Three or more liquid crystal layers having mutually different absorption axis bearings may also be provided.

Moreover, the present disclosure may have the following configurations.
(1)

A projection screen including:

a display member; and

a light-controlling layer stacked on the display member,

the light-controlling layer including

a pair of conductive layers disposed to oppose each other,

a liquid crystal layer provided between the pair of conductive layers, the liquid crystal layer including a liquid crystal and a dichroic pigment, and

a photoconductive layer provided between one of the pair of conductive layers and the liquid crystal layer, and configured to have an application region whose resistance varies in accordance with application of light having a first wavelength.
(2)

The projection screen according to (1), in which the light having the first wavelength is light having a wavelength different from a wavelength of light that configures an image.
(3)

The projection screen according to (1) or (2), in which the light having the first wavelength is light having a wavelength ranging from 350 nm to 420 nm.
(4)

The projection screen according to (1) or (2), in which the light having the first wavelength is light having a wavelength ranging from 700 nm to 2.5 μm.
(5)

The projection screen according to any of (1) to (4), in which the light-controlling layer has reflectance or transmittance that varies in accordance with the application of the light having the first wavelength.
(6)

The projection screen according to any of (1) to (5), in which the light-controlling layer is colored by the application of the light having the first wavelength.
(7)

The projection screen according to any of (1) to (6), in which the display member includes any of a hologram, a half mirror, a surface plasmon particle, a cholesteric liquid crystal, and a Fresnel lens.
(8)

The projection screen according to any of (1) to (7), in which the photoconductive layer includes an organic photo conducting agent.
(9)

The projection screen according to any of (1) to (8), in which the light-controlling layer includes a first light-controlling layer and a second light-controlling layer, the first light-controlling layer having a first liquid crystal layer and the second light-controlling layer having a second liquid crystal layer, the second liquid crystal layer having an absorption axis different from an absorption axis of the first liquid crystal layer.
(10)

The projection screen according to (9), in which an angle made by the absorption axis of the first liquid crystal layer and the absorption axis of the second liquid crystal layer is 90°.
(11)

The projection screen according to any of (1) to (10), in which the light-controlling layer includes a transparent member on a surface of a side opposite to the display member.
(12)

The projection screen according to any of (2) to (11), in which the display member has light-transmissivity to light having a wavelength other than the wavelength that configures the image in a directly viewing view and the first wavelength.
(13)

A projection display apparatus including:

a light source device;

an image-generating optical system that generates image light by modulating light from the light source device on a basis of an inputted image signal;

a projection optical system that projects image light generated by the image-generating optical system; and

a projection screen that displays the image light projected from the projection optical system,

the projection screen including

a display member, and

a light-controlling layer stacked on the display member,

the light-controlling layer including

a pair of conductive layers disposed to oppose each other,

a liquid crystal layer provided between the pair of conductive layers, the liquid crystal layer including a liquid crystal and a dichroic pigment, and

a photoconductive layer provided between one of the pair of conductive layers and the liquid crystal layer, and configured to have an application region whose resistance changes in accordance with application of light having a first wavelength.
(14)

The projection display apparatus according to (13), in which the light source device includes a light source that generates the image light and a light source of the light having the first wavelength.
(15)

The projection display apparatus according to any of (13) or (14), in which the light having the first wavelength uses an optical system common to the image light.

This application claims the benefits of Japanese Priority Patent Application No. 2017-026534 filed on Feb. 16, 2017 with the Japan Patent Office, the entire content of which is incorporated herein by reference.

It should be understood that those skilled in the art could conceive various modifications, combinations, sub-combinations, and alterations depending on design requirements and other factors, insofar as they are within the scope of the appended claims or the equivalents thereof.

1. A projection screen comprising:
a display member; and
a light-controlling layer stacked on the display member,
the light-controlling layer including
a pair of conductive layers disposed to oppose each other,
a liquid crystal layer provided between the pair of conductive layers, the liquid crystal layer including a liquid crystal and a dichroic pigment, and
a photoconductive layer provided between one of the pair of conductive layers and the liquid crystal layer, and configured to have an application region whose resistance varies in accordance with application of light having a first wavelength.

2. The projection screen according to claim 1, wherein the light having the first wavelength is light having a wavelength different from a wavelength of light that configures an image.

3. The projection screen according to claim 1, wherein the light having the first wavelength is light having a wavelength ranging from 350 nm to 420 nm.

4. The projection screen according to claim 1, wherein the light having the first wavelength is light having a wavelength ranging from 700 nm to 2.5 μm.

5. The projection screen according to claim 1, wherein the light-controlling layer has reflectance or transmittance that varies in accordance with the application of the light having the first wavelength.

6. The projection screen according to claim 1, wherein the light-controlling layer is colored by the application of the light having the first wavelength.

7. The projection screen according to any claim 1, wherein the display member includes any of a hologram, a half mirror, a surface plasmon particle, a cholesteric liquid crystal, and a Fresnel lens.

8. The projection screen according to claim 1, wherein the photoconductive layer includes an organic photo conducting agent.

9. The projection screen according to claim 1, wherein the light-controlling layer includes a first light-controlling layer and a second light-controlling layer, the first light-controlling layer having a first liquid crystal layer and the second light-controlling layer having a second liquid crystal layer, the second liquid crystal layer having an absorption axis different from an absorption axis of the first liquid crystal layer.

10. The projection screen according to claim 9, wherein an angle made by the absorption axis of the first liquid crystal layer and the absorption axis of the second liquid crystal layer is 90°.

11. The projection screen according to claim 1, wherein the light-controlling layer comprises a transparent member on a surface of a side opposite to the display member.

12. The projection screen according to any claim 1, wherein the display member has light-transmissivity to light having a wavelength other than the wavelength that configures the image in a directly viewing view and the first wavelength.

13. A projection display apparatus comprising:
a light source device;
an image-generating optical system that generates image light by modulating light from the light source device on a basis of an inputted image signal;
a projection optical system that projects image light generated by the image-generating optical system; and
a projection screen that displays the image light projected from the projection optical system,
the projection screen including
a display member, and
a light-controlling layer stacked on the display member,
the light-controlling layer including
a pair of conductive layers disposed to oppose each other,
a liquid crystal layer provided between the pair of conductive layers, the liquid crystal layer including a liquid crystal and a dichroic pigment, and
a photoconductive layer provided between one of the pair of conductive layers and the liquid crystal layer, and configured to have an application region whose resistance changes in accordance with application of light having a first wavelength.

14. The projection display apparatus according to claim 13, wherein the light source device comprises a light source that generates the image light and a light source of the light having the first wavelength.

15. The projection display apparatus according to claim 13, wherein the light having the first wavelength uses an optical system common to the image light.
